(19) United States
(12) Patent Application Publication
(10) Pub. No.: US 2005/0022212 A1
(43) Pub. Date: Jan. 27, 2005

(54) Software driver code usage

(76) Inventor: James Samuel Bowen, Birmingham (GB)

Correspondence Address: MCGARRY BAIR PC, 171 MONROE AVENUE, N.W., SUITE 600, GRAND RAPIDS, MI, 49503, US

(21) Appl. No.: 10/483,708

(22) PCT Filed: Jul. 11, 2002
(86) PCT No.: PCT/GB02/03194

(30) Foreign Application Priority Data
Jul. 11, 2001 (GB) 0226869.9

(51) Int. Cl. G06F 9/46

(52) U.S. Cl. 719/321; 719/327

(57) ABSTRACT

A method of providing a device with software driver code for operating the device with an accessory when operably coupled thereto. The method includes storing said software driver code on said accessory (404). On operably coupling said accessory to said device (406), either: said software driver code is exchanged from the accessory via a communication means to the device (416) or said software drivercode stored in said accessory is operated in situ on said accessory (408). An accessory, a communication device and a communication system are also provided. In this manner, a device is no longer required to maintain enough available memory in which to store the software drivers for a number of potential accessories.

### FIELD OF THE INVENTION

This invention relates to operating driver software code from, or uploading driver software code to, a device. The invention is applicable to, but not limited to, driver software code for an accessory of a communication device such as a cellular phone.

### BACKGROUND OF THE INVENTION

In the field of fixed and wireless communication technology, there is an ever-increasing demand for more functionality to be provided to subscriber equipment. Furthermore, there is an increasing demand by subscribers to personalise the functionality of their subscriber equipment to meet their individual (or group) needs.

Particularly in the context of personalising subscriber equipment, there has been a desire in the field of fixed and wireless communication technology to download software to subscriber equipment. Hence, with the evolution of mobile (as well as fixed) Internet access, in conjunction with the rapid development of data packet transfer technologies in the radio frequency domain, substantial software downloads, to facilitate terminal adaptation and personalisation, is fast becoming a reality.

In the context of the present invention, the term “download” is to be understood as meaning taking information off, or receiving information from, another device. In contrast, the term “upload” is to be understood as meaning putting information on, or transmitting information to, another device.

It is known that software download from a server (or content provider) can be initiated in a number of ways.

Such downloads may include entire software applications and software patches to remedy specific technical faults that have been identified following an initial release of software code.

Software downloads may also be content specific in that it is accessed on a demand basis from a content provider and may therefore appear to be general internet information, such as e-commerce messages, web pages, etc. Furthermore, it is known that software can be provided in the form of code on an adjunct “plug-in” memory expansion cards or SIM cards for use within subscriber equipment.

In the next generation of mobile communication systems, such as the universal system for mobile communication (UMTS), mobile subscriber units will be able to access the internet directly via packet switched bearers across both an air-interface and in a wireline or optical network. It is envisaged that such subscriber equipment will be capable of operating with numerous accessories, for example MP3 players, wireless headsets, short message service (SMS) keypads, digital cameras, remote controls.

Furthermore, it is envisaged that services in the future will be de-coupled from the communication network. This implies that the roles of network operators, service providers and manufacturers can be clearly distinguished and supported independently by unrelated parties.

Therefore, in theory, download of either software or content can be acquired from any accessible source.

Moreover, it will be appreciated that the unregulated nature of the internet, although desirable, leads to a very insecure network in which a subscriber can inadvertently compromise its own subscriber equipment functionality by downloading incompatible or deliberately malicious code. In the former instance, contemporaneous operation of downloaded code with existing software/firmware within the subscriber unit may inadvertently cause unit failure. The same scenario applies to any downloading of code to enable a subscriber unit to operate with a particular accessory.

Therefore, there are inherent risks associated with both the augmentation in the number of software applications and accessories supported by the subscriber equipment and the update or replacement of code from, generally, non-vetted data repositories over a non-secure communication resource, such as the internet.

In the area of third generation wireless communications, a means of providing automatic secure transfer of applications, applets and content has been put forward in the Mobile Execution Environment (MEXE) proposal in the 3^{rd} generation partnership project (3GPP T2). In the MExE proposal, an authentication mechanism is based on the CCITT X.509 digital certificate scheme that allows a subscriber unit and server to authenticate each other effectively. A standalone encryption mechanism is used to provide privacy for downloaded software (or content).

The current MEXE approach for secured software/content download is to sign the software/content with a digital certificate that is authorised by a Trust Certificate Authority. The Certificate will uniquely identify the server to authenticate to the subscriber that the downloaded software/content comes from the trusted server; such a scenario exists where, for example, the server belongs to a handset manufacturer. Therefore, Certificates essentially contain a digital signature, unique to the equipment, and an encryption key for subsequent use in decoding data packets (or the like) that are transferred between the subscriber unit and a server.

Hence, the over-riding current philosophy being applied to address the inherent problems associated with the demand for ever-more software downloads, is to certify the software/code providers. Clearly, such a philosophy focuses equipment/device manufacturers on the provision of increased memory capabilities of the particular equipment/device. Such increased memory capabilities are deemed essential to handle each of the various software applications and accessories that a user of the equipment/device is expected to be interested in.

Associated with the aforementioned devices is the concept of software drivers. These software drivers typically take the form of software code that is stored in the particular device to facilitate the running and operation of particular software algorithms in the device. Furthermore, many current electronic devices are generally configured with the ability to connect a variety of accessories, in order to enhance the device's functionality to its user.

The aforementioned driver storage approach has a number of disadvantages. Firstly, the device is required to maintain enough memory in which to store the code for all of the software drivers. The inventor of the present invention has recognised that, if it was not necessary for the device to store all the software driver codes, the corresponding memory could be used for either: other applications, or it could be left out, thereby reducing the costs involved with producing the device as well as potentially reducing the size of the device.

A second problem with the present arrangement of storing the code for all software drivers in the communication device is that a particular accessory may not be fully developed when the device is ready to be sold. In order for the software driver for the accessory to be installed in the device, delivery of the device will have to be delayed until the software driver is available.

Alternatively the device can be sold without the software driver, and if necessary have the software driver installed at a later date. This can be inconvenient for the owner of the device, as it requires the owner of the device to arrange for the software driver to be installed, in order for the user to be able to use the accessory.

A yet further problem arises when software driver upgrades are required, or enhanced accessories are bought onto the market place. In such a situation, each and every communication device needs to be able to support future enhancements, or be re-programmed with the necessary software driver or software driver upgrade.

Thus there exists a need in the field of the present invention for an improved arrangement to provide software driver code to a device wherein the above-mentioned disadvantages associated with prior art approaches may be alleviated.

### STATEMENT OF INVENTION

In accordance with a first aspect of the present invention, there is provided a method of providing a device with software driver code, for operating the device with an accessory when operably coupled thereto, as claimed in claim 1.

In accordance with a second aspect of the present invention, there is provided a communication device, as claimed in claim 12.

In accordance with a third aspect of the present invention, there is provided an accessory for a communication device, as claimed in claim 14.

In accordance with a fourth aspect of the present invention, there is provided a storage medium storing processor-implementable instructions, as claimed in claim 16.

In accordance with a fifth aspect of the present invention, there is provided an accessory for a device, as claimed in claim 17.

In accordance with a sixth aspect of the present invention, there is provided a communication device, as claimed in claim 25.

In accordance with a seventh aspect of the present invention, there is provided a communication system, as claimed in claim 27.

Further aspects of the invention are as claimed in the dependent claims.

In summary, the present invention provides a mechanism for each accessory to store its own software driver code, in contrast to the communication device itself storing the codes for all potential software drivers that may be required to drive the various accessories. In this manner, when the accessory is connected to the device, the device is able to download/upload the software driver code from, or utilise the software driver code from within, the accessory.

In particular, the preferred embodiment of the present invention provides a method of operating a device, for example a cellular phone, with an accessory by improved management of memory space of the device.

### BRIEF DESCRIPTION OF THE DRAWINGS

Exemplary embodiments of the present invention will now be described, with reference to the accompanying drawings, in which:

FIG. 1 shows a block diagram of a subscriber unit adapted to support the inventive concepts of the preferred embodiments of the present invention.

FIG. 2 shows a device-accessory arrangement prior to a software driver code exchange, in accordance with a preferred embodiment of the invention.

FIG. 3 shows a device-accessory arrangement highlighting the memory change after a software driver code exchange operation, in accordance with a preferred embodiment of the invention.

FIG. 4 shows a flowchart of a device utilising software driver code stored in an accessory, in accordance with the preferred embodiments of the present invention.

### DESCRIPTION OF PREFERRED EMBODIMENTS

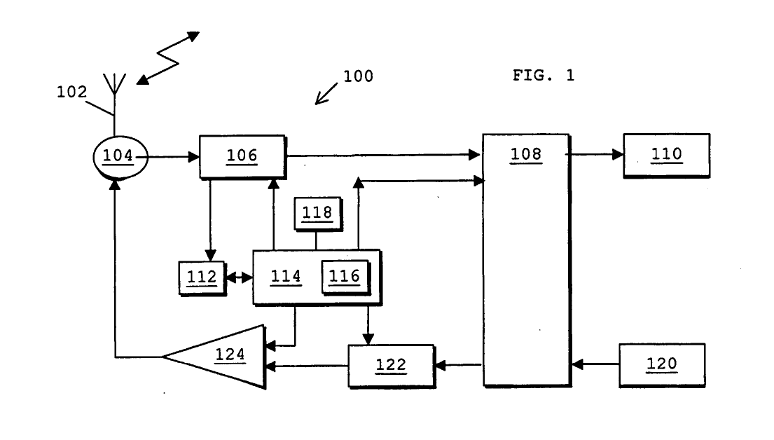

Referring first to FIG. 1, there is shown a block diagram of a subscriber unit 100 adapted to support the inventive concepts of the preferred embodiments of the present invention. The subscriber unit 100, in the context of the preferred embodiment of the invention is a cellular phone. As such, the subscriber unit 100 contains an antenna 102 preferably coupled to a duplex filter or circulator 104 that provides isolation between receive and transmit chains within the subscriber unit 100.

The receiver chain, as known in the art, includes scanning receiver front-end circuitry 106 (effectively providing reception, filtering and intermediate or base-band frequency conversion). The scanning front-end circuit is serially coupled to a signal processing function 108. An output from the signal processing function 108 is provided to a suitable output device 110, such as a screen or flat panel display.

The receiver chain also includes received signal strength indicator (RSSI) circuitry 112, which in turn is coupled to a controller 114 for maintaining overall subscriber unit control. The controller 114 is also coupled to the scanning receiver front-end circuitry 106 and the signal processing function 108 (generally realised by a DSP).

The controller 114 may therefore receive bit error rate (BER) or frame error rate (FER) data from recovered information. The controller is also coupled to a memory device 116 that stores operating regimes, such as decoding/encoding functions and the like. In accordance with the preferred embodiment of the present invention, the memory device 116 has been adapted such that it no longer allocates substantial memory space for storing numerous software driver codes, particularly software driver codes relating to a plurality of accessories.

A timer 118 is typically coupled to the controller 114 to control the timing of operations (transmission or reception of time-dependent signals) within the subscriber unit 100. The timer, together with the processor 108 and/or controller 114, has also been adapted to synchronise the subscriber unit 100 to an accessory for downloading/uploading of software driver code pertinent to the particular accessory, when the accessory is operably coupled to the subscriber unit 100.

It is within the contemplation of the invention that either the accessory or the subscriber unit 100 may initiate the exchange of software driver code, as and when required. In this regard, an exchange would constitute an upload operation if the accessory initiated the process, and an exchange would constitute a download operation if the subscriber unit 100 initiated the process.

As regards the transmit chain, this essentially includes an input device 120, such as a keypad, coupled in series through transmitter/modulation circuitry 122 and a power amplifier 124 to the antenna 102. The transmitter/modulation circuitry 122 and the power amplifier 124 are operationally responsive to the controller. The input device in the preferred embodiment of the invention also includes a RS232 and/or USB interface to facilitate a wireline exchange of the accessory's software driver code.

Of course, the various components within the subscriber unit 100 can be realised in discrete or integrated component form. Furthermore, it is within the contemplation of the invention that subscriber unit 100 is any device requiring software driver code to run software applications, or enable the device to work with the accessory operably coupled thereto. The subscriber unit 100 may be a cellular phone, a portable or mobile radio, a personal digital assistant, a laptop computer or a wirelessly networked PC that requires access to a communication system, or any other digital device capable of operating with driver dependent accessories.

In accordance with one embodiment of the invention, the signal processing function 108, memory device 116 and input device 120 have also been adapted to request, receive and store the accessory's software driver code, when the accessory is operably coupled to the subscriber unit 100.

Once the software driver code has been downloaded (or uploaded) to the subscriber unit 100, it is stored in the memory device 116, which could be random access memory (RAM) or non-volatile memory. The software driver code can then be executed from the subscriber unit 100 to allow the subscriber unit 100 and accessory to function together in their intended manner. In this manner, a subsequent accessory, when operably coupled to the subscriber unit 100, downloads its software driver code into RAM, thereby overwriting the software driver code of the previous accessory.

It is also within the contemplation of the invention that the software driver code may be uploaded from the accessory in cases where the accessory has the means to determine that it is connected to a new communication device that does not contain the appropriate software driver code to operate the accessory.

It is further within the contemplation of the invention that the software driver code may be stored and subsequently run in a secure environment within the subscriber unit 100, to restrict its access to certain resources, such as the SIM card. As such, a separate memory element (not shown) may be used. This will help prevent hacking of the software of the subscriber unit 100 via the accessory interface.

Preferably, once the software driver code has been downloaded/uploaded to the subscriber unit 100, the processor 108 performs an error detection and/or error correction procedure on the downloaded/uploaded code.

The error detection and/or error correction procedure may take any number of forms, for example a cyclic redundancy check to detect and/or correct for errors introduced into the software driver code during the download/upload operation. If it is found that an error has occurred, and dependent upon the level of data corruption, the subscriber unit 100 could:
(i) Request that the software driver code be re-uploaded by the accessory,
(ii) Re-download the software driver code, or
(iii) Attempt to correct the error(s) itself.

In the preferred embodiment of the invention, the subscriber unit 100 retains the latest downloaded/uploaded software driver code. Such retention of code is performed to address a problem when the accessory is disconnected from the subscriber unit 100.

This provides the advantage that if the accessory and subscriber unit 100 are disconnected by accident, or the accessory is a preferred accessory of the subscriber unit 100, for example a preferred plug-in game module of the user, then it is not necessary for the software driver code to be exchanged each time.

In an alternative embodiment of the invention, the subscriber unit 100 retains no software driver code when an accessory is disconnected. In this embodiment, the driver code is erased from memory, thereby making more memory available for other subscriber unit applications. However, for such an alternative embodiment, it is preferred that the software driver code is retained in the memory element for a minimum period of time before the software driver code is cleared from memory.

Therefore, the alternative embodiment will still allow accidental disconnections between the subscriber unit 100 and the accessory to take place, without the need to exchange the software driver code each time—assuming that the phone and accessory are reconnected within this minimum period of time. In this alternative embodiment, it is envisaged that the minimum period of time may be dependent upon a number of factors, such as a type of subscriber unit 100, a type of accessory, or amount of software driver code to be exchanged. As such, it is envisaged that the minimum period of time may be user definable or pre-determined.

In a yet further alternative embodiment of the invention, no exchange of software driver code occurs, as the software driver code remains in the accessory. In this configuration, the software driver code is run directly from the accessory and only accessed by a device when the accessory is connected to the device.

Clearly, the subscriber unit 100 still benefits from this configuration, with regard to there being no requirement to apportion any memory space for storing any driver software. Furthermore, this configuration benefits from there being no requirement to exchange software driver code.

In particular, all the above configurations benefit from the fact that out-of-date or incompatible accessory driver software code will no longer be a problem. The accessory now has the burden of containing the appropriate software driver code to enable the subscriber unit 100 to operate with the accessory.

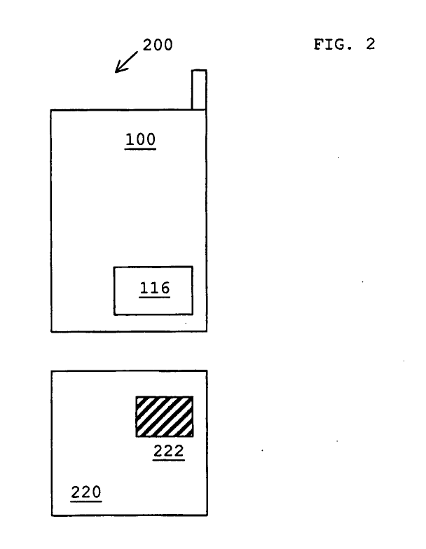

Referring now to FIG. 2, a device-accessory arrangement 200 prior to any software driver code exchange is shown, in accordance with the preferred embodiment of the invention.

The subscriber unit 100 is shown having a memory element 116 that, in accordance with the preferred embodiment of the present invention, initially contains no software driver code. The accessory 220 comprises non-volatile memory 222, for example read-only-memory (ROM), in which is stored the software driver code required for the subscriber unit 100 to operate with the accessory. The accessory 220 also comprises circuitry (not shown) and at least one processor that can be used by the subscriber unit 100 to access the non-volatile memory of the accessory 222, and thus the software driver code.

Each type of accessory would preferably have an identification code, which is used to uniquely identify the accessory to the particular software driver code required. Therefore, when a different accessory is connected to the subscriber unit 100, the subscriber unit 100 recognises the fact that the software driver code from the previous accessory is not suitable for the new accessory. In such a case, the original software driver code stored in memory is either erased or over-written with the new software driver code exchanged from the new accessory.

The types of accessories for which software drivers are required will in general have a processor and memory 222 in order to perform their intended operations. Preferably a part of this memory 222 and this processor would be used for storing the software driver code and uploading/downloading the code to the connected-to subscriber unit 100. In this regard, the accessory 220 may have a dedicated area of memory 222 and/or a dedicated processor for storing and uploading/downloading the software driver code.

Examples of the types of accessories with which the present invention could be used are MP3 players, wireless headsets short message service (SMS) keypads, digital cameras and remote controls. However, it is within the contemplation of the invention that the inventive concepts are not limited to the types of accessories described above. In particular, the inventor of the present invention envisages that the invention encompasses any type of accessory that requires the device to use a software driver.

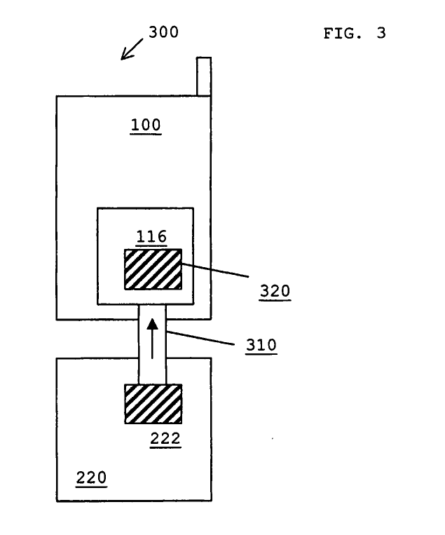

Referring now to FIG. 3, a device-accessory arrangement 300 is shown, highlighting the memory change after a software driver code download/upload operation, in accordance with the preferred embodiment of the invention. The subscriber unit 100 preferably includes a self-checking mechanism, say in processor 108 of FIG. 1, so that when the accessory 220 is operably coupled to the subscriber unit 100, the first function that the processor performs in relation to the accessory 220 is to compare the details of the accessory 220 with the driver software code 320 stored in memory device 116. The self-checking mechanism initiates an exchange operation of the new software driver code if there is not a match.

The self-checking mechanism may include the subscriber unit 100 sending a single command to the accessory via the communication means 310. The command would instruct the accessory 220 to transmit the software driver code 222 to the subscriber unit 100. However, it is within the contemplation of the invention that more elaborate exchange of information, including forms of handshaking and/or acknowledgement signalling between the subscriber unit 100 and the accessory 220, may take place.

The subscriber unit 100 and accessory 220 are connected via a communication means 310. Preferably, the communication means 310 takes the form of a universal serial bus (USB) interface or an RS232 serial interface connection on one or both of the accessory 220 and subscriber unit 100, together with a cable linking the two, using electrical signals for communication therebetween.

It is within the contemplation of the invention that alternative types of communication means could be used to facilitate the software driver code exchange operation. An example of an alternative software driver code exchange operation could be an over-the air programming (OTAP) operation using the scanning front-end circuit 106, processor 108 and memory device 116 of FIG. 1. Complementary radio frequency (RF) transmitter circuitry, similar to that described with respect to the transmit chain of the subscriber unit 100 of FIG. 1, would be located in the accessory 220. For this embodiment, RF transmissions would be used for the software driver code exchange operation.

A yet further alternative embodiment would comprise an infrared transmit/receive pair on each of the subscriber unit 100 and accessory 220, making use of an infrared beam for communication between the subscriber unit 100 and the accessory 220.

Hence, it is within the contemplation of the invention that an accessory 220 may be re-programmed to store and transmit up-to-date software driver code as described above. More generally, according to the preferred embodiment of the present invention, such re-programming of software driver code may be implemented in a respective accessory 220 in any suitable manner. For example, a new memory chip may be added to a conventional accessory 220, or alternatively existing parts of a conventional accessory 220 may be adapted, for example by reprogramming one or more processors therein. As such the required adaptation may be implemented in the form of processor-implementable instructions stored on a storage medium, such as a floppy disk, hard disk, programmable ROM (PROM), RAM or any combination of these or other storage multimedia.

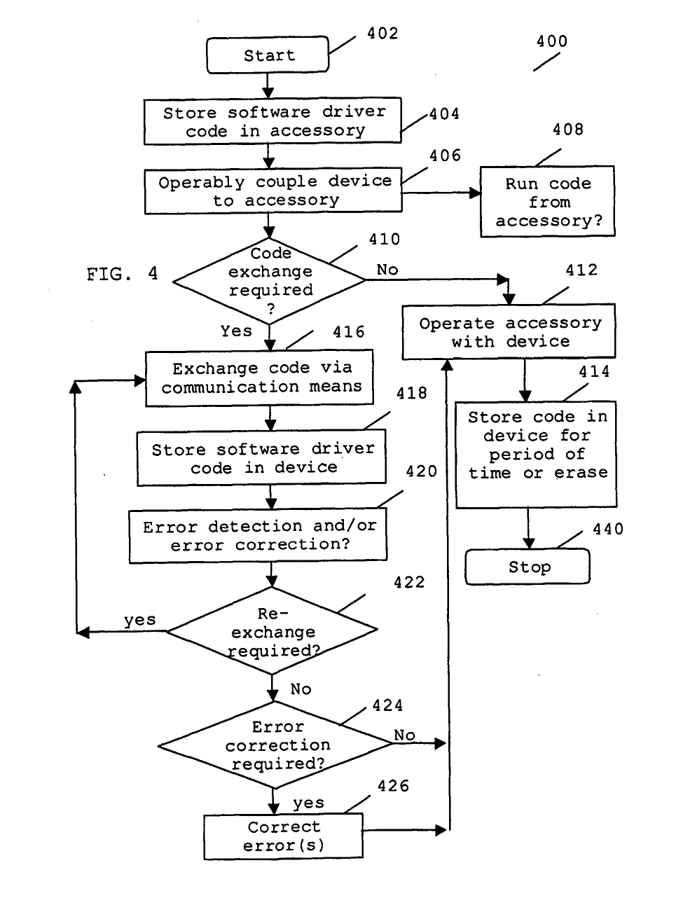

Referring now to FIG. 4, a flowchart 400 of a software driver code exchange mechanism is shown, in accordance with the preferred embodiments of the present invention. The process is shown starting at step 402 and software driver code is stored in the accessory, as shown in step 404.

When the accessory is operably coupled to the device (for example subscriber unit 100), in any suitable manner such as wirelessly coupled, fixedly attached, removably attached etc., in step 406, a determination is made as to whether the accessory's software driver code can be operated from the accessory by the device itself, as shown in step 408. If it is determined that the software driver code should be run from the accessory in situ, due to the prevailing conditions such as excessive download/upload time or limited time available to operate the device with the accessory, such remote operation is performed.

However, if it is not feasible or reasonable to perform such a remote process, a determination is made as to whether software driver code should be exchanged, as shown in step 410. Such a determination may be based on whether the device already contains the appropriate software driver code, perhaps from a previous exchange of software driver code. If an exchange is not required in step 410, the device is operated with the accessory, as shown in step 412.

However, if an exchange of software driver code is required in step 410, such exchange is performed via appropriate communication means, as described above, and as shown in step 416. The exchanged software driver code is stored in the device, as in step 418 and error detection and/or error correction checks optionally performed on the exchanged code, as shown in step 420.

If sufficient errors are detected to merit a further exchange of the software driver code, in step 422, repeating the steps 416 to 420, as shown, performs such a further exchange. If a further exchange of code is not required, a determination is made as to whether error correction is possible, as shown in step 424. Such error correction is performed, if appropriate, as in step 426.

Once the software driver code has been successfully transferred, the device can be operated with the accessory, as shown in step 412. After disconnection of the accessory from the device, the software driver code may be stored for a period of time, as discussed above, or the software driver code may be erased from the memory element of the device to make memory space available, as shown in step 414. The process finishes in step 440.

In this manner, when the accessory is connected to the device, the device is able to download/upload the software driver code from, or utilise the software driver code from within, the accessory as appropriate. Such an operation is made possible as a result of the accessory storing its particular software driver code.

It will be understood that the software download/upload operation of the preferred embodiment of the present invention, or the operation of the software driver code in situ in an alternative embodiment, as described above, provides at least some of the following advantages:
(i) A communication device is no longer required to maintain substantial amounts of memory in which to store the software drivers for a number of accessories. As a consequence the corresponding memory space of the communication device may be used for other applications or purposes;
(ii) Alternatively, a smaller capacity memory element may be used in the communication device, which:
   (a) potentially requires less power consumption and/or
   (b) leads to a reduction in manufacturing cost of the memory element and hence the communication device and/or
   (c) potentially reduces the size of the communication device.
(iii) When the software driver code is stored and run in a secure environment within the device, thereby restricting its access to certain resources such as the SIM card, an added level of security from software hacking of the device via the device/accessory interface is achieved.

Thus a mechanism for providing software uploads has been described wherein the aforementioned disadvantages associated with prior art software uploads have been substantially alleviated.

1. A method of providing a device with software driver code for operating the device with an accessory when operably coupled thereto, the method comprising the steps of:
storing said software driver code on said accessory;
exchanging said software driver code from the accessory via a communication means to the device, on operably coupling said accessory to said device, for operating the accessory from the device; and
storing temporarily said software driver code on said device for a period of time.

2. The method of providing a device with software driver code according to claim 1, wherein the step of exchanging includes the step of:
downloading said software driver code from said accessory; or
uploading said software driver code to said device.

3. The method of providing a device with software driver code according to claim 1, wherein the step of exchanging includes the step of:
operably coupling said device to said accessory using a wired interface, for example a USB interface or an RS232 serial interface.

4. The method of providing a device with software driver code according to claim 1, wherein the step of exchanging includes the step of:
operably coupling said device to said accessory using a radio frequency interface or an infrared interface.

5. The method of providing a device with software driver code according to claim 1, when the software driver code is to be exchanged to a memory element of the device, the method further comprising the step of:
checking a status of said memory element on operably coupling said device to said accessory in order to determine whether a software driver code exchange is required.

6. The method of providing a device with software driver code according to claim 5, the method further comprising the step of:
exchanging software driver code to said device prior to operating said accessory.

7. The method of providing a device with software driver code according to claim 1, the method further comprising, in relation to the step of exchanging, the step of:
performing an error detection and/or error checking operation of the exchanged software driver code.

8. The method of providing a device with software driver code according to claim 1, the method further comprising the steps of:
identifying said accessory by an identification code; and
confirming that said software driver code needs to be exchanged in response to said identified identification code.

9. The method of providing a device with software driver code according to claim 1, the method further comprising the steps of:
retaining the latest exchanged software driver code in said device for a period of time after disconnection of said accessory; or
erasing said software driver code in said device after disconnection of said accessory.

10. The method of providing a device with software driver code according to claim 9, wherein the step of erasing includes the step of:
erasing said software driver code a period of time after disconnection of the accessory from the device.

11. The method of providing a device with software driver code according to claim 10, wherein the period of time is user definable or pre-determined and/or dependent upon at least one of the following:
type of device, type of accessory, or amount of software driver code to be exchanged.

12. A communication device, adapted to operate the steps of method claim 1.

13. The communication device according to claim 12, wherein the device is one of:
a cellular phone, a portable or mobile radio, a personal digital assistant, a laptop computer, a wirelessly networked PC.

14. A storage medium storing processor-implementable instructions for controlling one or more processors to carry out the method of claim 1.

15. A communication device for operable coupling to an accessory by communication means wherein said accessory includes a memory element storing software driver code for operating said accessory when operably coupled to said communication device, the communication device characterised by a memory element storing software driver code for a temporary period of time following exchange of said software driver code from the accessory via said communication means to the communication device.

16. The communication device according to claim 15, wherein said communication means is a wired interface, for example a USB interface or an RS232 serial interface, adapted to exchange said software driver code between said accessory and said communication device.

17. The communication device according to claim 15, wherein said communication means is an infrared link or a radio frequency link for exchanging said software driver code from said memory element of said accessory to said communication device.

18. The communication device according to claims 15, the communication device further comprising:
software driver code error detection and/or error correction means for detecting and/or correcting any errors in the exchange of software driver code between said communication device and said accessory.

19. The communication device according to claim 15, the communication device further comprising:
self-checking means for confirming said software driver code of said accessory is required by said communication device to operate with said accessory, prior to exchanging said software driver code.
